(19) United States
(12) Patent Application Publication
(10) Pub. No.: US 2024/0220666 A1
(43) Pub. Date: Jul. 4, 2024

(54) HARDWARE ACCESS CONTROL AT SOFTWARE DOMAIN GRANULARITY

(71) Applicant: Intel Corporation, Santa Clara, CA (US)

(72) Inventors: Luis Sergio Kida, Beaverton, OR (US); Reshma Lal, Portland, OR (US)

(73) Assignee: Intel Corporation, Santa Clara, CA (US)

(21) Appl. No.: 18/148,689

(22) Filed: Dec. 30, 2022

(51) Int. Cl. G06F 21/71; H04W 12/71

(52) U.S. Cl. CPC G06F 21/71; H04W 12/71

(57) ABSTRACT

An apparatus comprises a compute complex comprising one or more processing resources to execute a software process identified by a software identifier (SWID), at least one hardware module, a communication fabric to provide a communication pathway between the compute complex, the at least one hardware module, and at least one memory device, and at least one memory management unit to provide access control to the memory device based at least in part on the software identifier.

### BACKGROUND

Smart Network Interface Controllers (NICs) provide transport services and various acceleration services such as remote direct memory access (RDMA) and storage to host software. As cloud service providers (CSPs) migrate platform and infrastructure control to a new class of smart NIC, infrastructure processing units (IPUs). Infrastructure processing units, which are used to implement the next generation of smart network interface cards, open a significant security threat potential. Security sensitive workloads need protection of customer data during transport, RDMA, storage etc.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1A is a simplified block diagram of at least one embodiment of a computing environment, according to embodiments.

FIG. 1B is a simplified block diagram of at least one embodiment of a computing environment, according to embodiments.

FIG. 2 is a simplified block diagram of at least one embodiment of an infrastructure processing unit in which hardware access control at software domain granularity may be implemented, according to embodiments.

FIGS. 3A-3C illustrate various implementations of an infrastructure processing unit in which hardware access control at software domain granularity may be implemented, according to embodiments.

FIG. 4 is a simplified flow diagram of at least one embodiment of a method to implement an infrastructure processing unit in which hardware access control at software domain granularity, in accordance with some embodiments.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

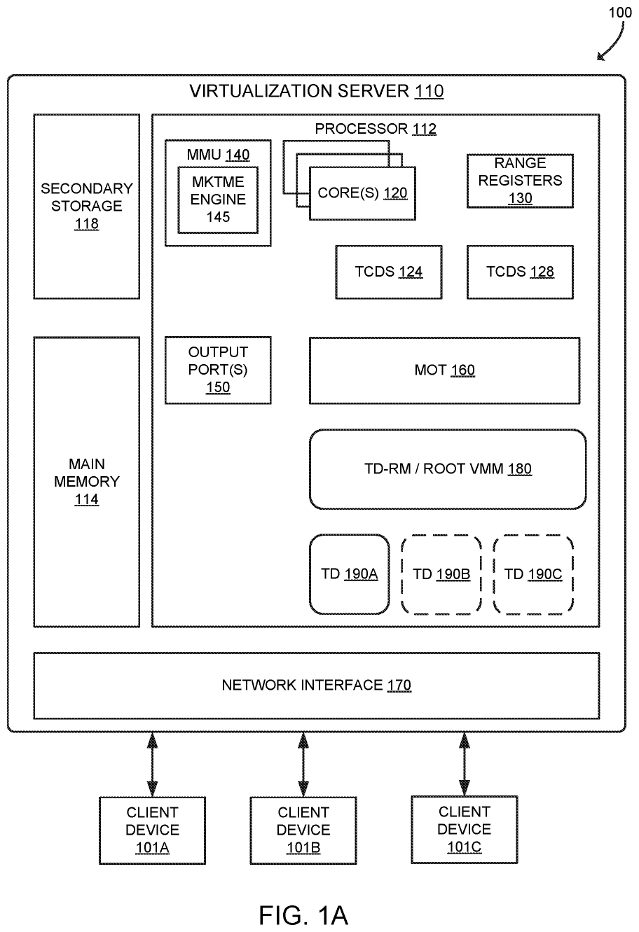

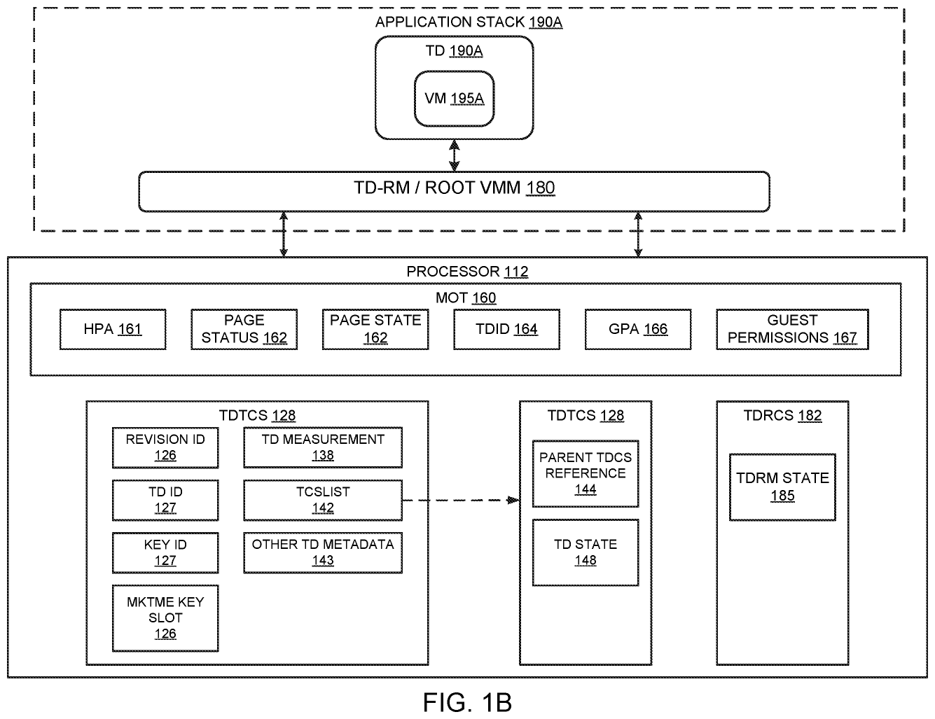

FIG. 1A is a block diagram illustrating an example computing system that may provide hardware access control, in accordance with embodiments. The virtualization system 100 includes a virtualization server 110 that supports a number of client devices 101A-101C. The virtualization server 110 includes at least one processor 112 (also referred to as a processing device) that executes a trusted domain root of trust (TDRM) 180. The TDRM 180 may include a virtual machine manager (VMM) (which may also be referred to as hypervisor) that may instantiate one or more trusted domains (TDs) 190A-190C accessible by the client devices 101A-101C via a network interface 170. The client devices 101A-101C may include, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device.

A trusted domain may refer to a tenant (e.g., customer) workload. The tenant workload can include an OS alone along with other ring-3 applications running on top of the operating system (OS) or can include a virtual machine (VM) running on top of a VMM along with other ring-3 applications, for example. In implementations of the disclosure, each trusted domain may be cryptographically isolated in memory using a separate exclusive key for encrypting the memory (holding code and data) associated with the trusted domain.

Processor 112 may include one or more cores 120 (also referred to as processing cores 120), range registers 130, a memory management unit (MMU) 140, and output port(s) 150. FIG. 1B is a schematic block diagram of a detailed view of a processor core 120 executing a TDRM 180 in communication with a MOT 160 and one or more trust domain control structure(s) (TDCS(s)) 124 and trust domain thread control structure(s) (TDTCS(s)) 128, as shown in FIG. 1A. TDTCS and TD-TCS may be used interchangeable herein. Processor 112 may be used in a system that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another implementation, processor 112 may be used in a system-on-chip (SoC) system.

The computing system 100 is representative of processing systems based on micro-processing devices available from Intel Corporation of Santa Clara, Calif., although other systems (including PCs having other micro-processing devices, engineering workstations, set-top boxes and the like) may also be used. In one implementation, sample system 100 executes a version of the WINDOWS™ operating system available from Microsoft Corporation of Redmond, Wash., although other operating systems (UNIX and Linux for example), embedded software, and/or graphical user interfaces, may also be used. Thus, implementations of the disclosure are not limited to any specific combination of hardware circuitry and software.

The one or more processing cores 120 execute instructions of the system. The processing core 120 includes, but is not limited to, pre-fetch logic to fetch instructions, decode logic to decode the instructions, execution logic to execute instructions and the like. In an implementation, the computing system 100 includes a component, such as the processor 112 to employ execution units including logic to perform algorithms for processing data.

The virtualization server 110 includes a main memory 114 and a secondary storage 118 to store program binaries and OS driver events. Data in the secondary storage 118 may be stored in blocks referred to as pages, and each page may correspond to a set of physical memory addresses. The virtualization server 110 may employ virtual memory management in which applications run by the core(s) 120, such as the trusted domains 190A-190C, use virtual memory addresses that are mapped to guest physical memory addresses, and guest physical memory addresses are mapped to host/system physical addresses by MMU 140.

The core 120 may execute the MMU 140 to load pages from the secondary storage 118 into the main memory 114 (which includes a volatile memory and/or a nonvolatile memory) for faster access by software running on the processor 112 (e.g., on the core). When one of the trusted domains 190A-190C attempts to access a virtual memory address that corresponds to a physical memory address of a page loaded into the main memory 114, the MMU 140 returns the requested data. The core 120 may execute the VMM portion of TDRM 180 to translate guest physical addresses to host physical addresses of main memory and provide parameters for a protocol that allows the core 120 to read, walk and interpret these mappings.

In one implementation, processor 112 implements a trusted domain architecture and ISA extensions (TDX) for the trusted domain architecture. The trusted domain architecture provides isolation between trusted domain workloads 190A-190C and from CSP software (e.g., TDRM 180 and/or a CSP VMM (e.g., root VMM 180)) executing on the processor 112). Components of the trusted domain architecture can include 1) memory encryption via multi-key total memory encryption (MK-TME) engine 145, 2) a resource management capability referred to herein as the TDRM 180, and 3) execution state and memory isolation capabilities in the processor 112 provided via a MOT 160 and via access-controlled trusted domain control structures (i.e., TDCS 124 and TDTCS 128). The TDX architecture provides an ability of the processor 112 to deploy trusted domains 190A-190C that leverage the MK-TME engine 145, the MOT 160, and the access-controlled trusted domain control structures (i.e., TDCS 124 and TDTCS 128) for secure operation of trusted domain workloads 190A-190C.

In implementations of the disclosure, the TDRM 180 acts as a host and has full control of the cores 120 and other platform hardware. A TDRM 180 assigns software in a trusted domain 190A-190C with logical processor(s). The TDRM 180, however, cannot access a trusted domain's 190A-190C execution state on the assigned logical processor(s). Similarly, a TDRM 180 assigns physical memory and I/O resources to the TDs 190A-190C, but is not privy to access the memory state of a trusted domain 190A due to separate encryption keys, and other integrity and replay controls on memory.

With respect to the separate encryption keys, the processor may utilize the MK-TME engine 145 to encrypt (and decrypt) memory used during execution. With total memory encryption (TME), any memory accesses by software executing on the core 120 can be encrypted in memory with an encryption key. MK-TME is an enhancement to TME that allows use of multiple encryption keys (the number of supported keys is implementation dependent). The processor 112 may utilize the MKTME engine 145 to cause different pages to be encrypted using different MK-TME keys. The MK-TME engine 145 may be utilized in the trusted domain architecture described herein to support one or more encryption keys per each trusted domain 190A-190C to help achieve the cryptographic isolation between different CSP customer workloads. For example, when MK-TME engine 145 is used in the trusted domain architecture, the CPU enforces by default that trusted domain (all pages) are to be encrypted using a trusted domain-specific key. Furthermore, a trusted domain may further choose specific trusted domain pages to be plain text or encrypted using different ephemeral keys that are opaque to CSP software.

Each trusted domain 190A-190C is a software environment that supports a software stack consisting of VMMs (e.g., using virtual machine extensions (VMX)), OSes, and/or application software (hosted by the OS). Each trusted domain 190A-190C operates independently of other trusted domains 190A-190C and uses logical processor(s), memory, and I/O assigned by the TDRM 180 on the platform. Software executing in a trusted domain 190A-190C operates with reduced privileges so that the TDRM 180 can retain control of platform resources; however, the TDRM cannot affect the confidentiality or integrity of the trusted domain 190A-190C under defined circumstances. Further details of the trusted domain architecture and TDX are described in more detail below with reference to FIG. 1B.

Implementations of the disclosure are not limited to computer systems. Alternative implementations of the disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processing device (DSP), system on a chip, network computers (e.g., NetPC), set-top boxes, network hubs, wide area network (WAN) switches, or any other system that can perform one or more instructions in accordance with at least one implementation.

One implementation may be described in the context of a single processing device desktop or server system, but alternative implementations may be included in a multiprocessing device system. Computing system 100 may be an example of a ‘hub’ system architecture. The computing system 100 includes a processor 112 to process data signals. The processor 112, as one illustrative example, includes a complex instruction set computer (CISC) micro-processing device, a reduced instruction set computing (RISC) micro-processing device, a very long instruction word (VLIW) micro-processing device, a processing device implementing a combination of instruction sets, or any other processing device, such as a digital signal processing device, for example. The processor 112 is coupled to a processing device bus that transmits data signals between the processor 112 and other components in the computing system 100, such as main memory 114 and/or secondary storage 118, storing instruction, data, or any combination thereof. The other components of the computing system 100 may include a graphics accelerator, a memory controller hub, an I/O controller hub, a wireless transceiver, a Flash BIOS, a network controller, an audio controller, a serial expansion port, an I/O controller, etc. These elements perform their conventional functions that are well known to those familiar with the art.

In one implementation, processor 112 includes a Level 1 (Li) internal cache memory. Depending on the architecture, the processor 112 may have a single internal cache or multiple levels of internal caches. Other implementations include a combination of both internal and external caches depending on the particular implementation and needs. A register file is to store different types of data in various registers including integer registers, floating point registers, vector registers, banked registers, shadow registers, checkpoint registers, status registers, configuration registers, and instruction pointer register.

It should be noted that the execution unit may or may not have a floating-point unit. The processor 112, in one implementation, includes a microcode (ucode) ROM to store microcode, which when executed, is to perform algorithms for certain macroinstructions or handle complex scenarios. Here, microcode is potentially updateable to handle logic bugs/fixes for processor 112.

Alternate implementations of an execution unit may also be used in micro controllers, embedded processing devices, graphics devices, DSPs, and other types of logic circuits. System 100 includes a main memory 114 (may also be referred to as memory 114). Main memory 114 includes a DRAM device, a static random-access memory (SRAM) device, flash memory device, or other memory device. Main memory 114 stores instructions and/or data represented by data signals that are to be executed by the processor 112. The processor 112 is coupled to the main memory 114 via a processing device bus. A system logic chip, such as a memory controller hub (MCH) may be coupled to the processing device bus and main memory 114. An MCH can provide a high bandwidth memory path to main memory 114 for instruction and data storage and for storage of graphics commands, data and textures. The MCH can be used to direct data signals between the processor 112, main memory 114, and other components in the system 100 and to bridge the data signals between processing device bus, memory 114, and system I/O, for example. The MCH may be coupled to memory 114 through a memory interface. In some implementations, the system logic chip can provide a graphics port for coupling to a graphics controller through an Accelerated Graphics Port (AGP) interconnect.

The computing system 100 may also include an I/O controller hub (ICH). The ICH can provide direct connections to some I/O devices via a local I/O bus. The local I/O bus is a high-speed I/O bus for connecting peripherals to the memory 114, chipset, and processor 112. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

For another implementation of a system, the instructions executed by the processing device core 120 described above can be used with a system on a chip. One implementation of a system on a chip comprises of a processing device and a memory. The memory for one such system is a flash memory. The flash memory can be located on the same die as the processing device and other system components. Additionally, other logic blocks such as a memory controller or graphics controller can also be located on a system on a chip.

With reference to FIG. 1B, this figure depicts a block diagram of the processor 112 of FIG. 1A, according to one implementation of the disclosure. In one implementation, the processor 112 may execute an application stack 101 via a single core 120 or across several cores 120. As discussed above, the processor 112 may provide a trusted domain architecture and TDX to provide confidentiality (and integrity) for customer software running in the customer/tenants (i.e., trusted domains 190A) in an untrusted cloud service providers (CSP) infrastructure. The trusted domain (TD) architecture provides for memory isolation via a MOT 160, CPU state isolation that incorporates CPU key management via TDCS 124 and/or TDTCS 128; and CPU measurement infrastructure for trusted domain 190A software.

In one implementation, trusted domain architecture provides ISA extensions (referred to as trusted domainX) that support confidential operation of OS and OS-managed applications (virtualized and non-virtualized). A platform, such as one including processor 112, with trusted domainX enabled can function as multiple encrypted contexts referred to as trusted domains. For ease of explanation, a single trusted domain 190A is depicted in FIG. 1B. Each trusted domain 190A can run VMMs, VMs, OSes, and/or applications. For example, trusted domain 190A is depicted as hosting VM 195A.

In one implementation, the TDRM 180 may include as part of VMM functionality (e.g., root VMM). A VMM may refer to software, firmware, or hardware to create, run, and manage a virtual machine (VM), such as VM 195A. It should be noted that the VMM may create, run, and manage one or more VMs. As depicted, the VMM 110 is included as a component of one or more processing cores 120 of a processing device 122. The VMM 110 may create and run the VM 195A and allocate one or more virtual processors (e.g., vCPUs) to the VM 195A. The VM 195A may be referred to as guest 195A herein. The VMM may allow the VM 195A to access hardware of the underlying computing system, such as computing system 100 of FIG. 1A. The VM 195A may execute a guest operating system (OS). The VMM may manage the execution of the guest OS. The guest OS may function to control access of virtual processors of the VM 195A to underlying hardware and software resources of the computing system 100. It should be noted that, when there are numerous VMs 195A operating on the processing device 112, the VMM may manage each of the guest OSes executing on the numerous guests. In some implementations, a VMM may be implemented with the trusted domain 190A to manage the VMs 195A. This VMM may be referred to as a tenant VMM and/or a non-root VMM and is discussed in further detail below.

TDX also provides a programming interface for a trusted domain management layer of the trusted domain architecture referred to as the TDRM 180. A TDRM may be implemented as part of the CSP/root VMM. The TDRM 180 manages the operation of trusted domains 190A. While a TDRM 180 can assign and manage resources, such as CPU, memory and input/output (I/O) to trusted domains 190A, the TDRM 180 is designed to operate outside of a TCB of the trusted domains 190A. The TCB of a system refers to a set of hardware, firmware, and/or software component that have an ability to influence the trust for the overall operation of the system.

In one implementation, the trusted domain architecture is thus a capability to protect software running in a trusted domain 190A. As discussed above, components of the trusted domain architecture may include 1) Memory encryption via a TME engine having Multi-key extensions to TME (e.g., MK-TME engine 145 of FIG. 1A), 2) a software resource management layer (TDRM 180), and 3) execution state and memory isolation capabilities in the trusted domain architecture.

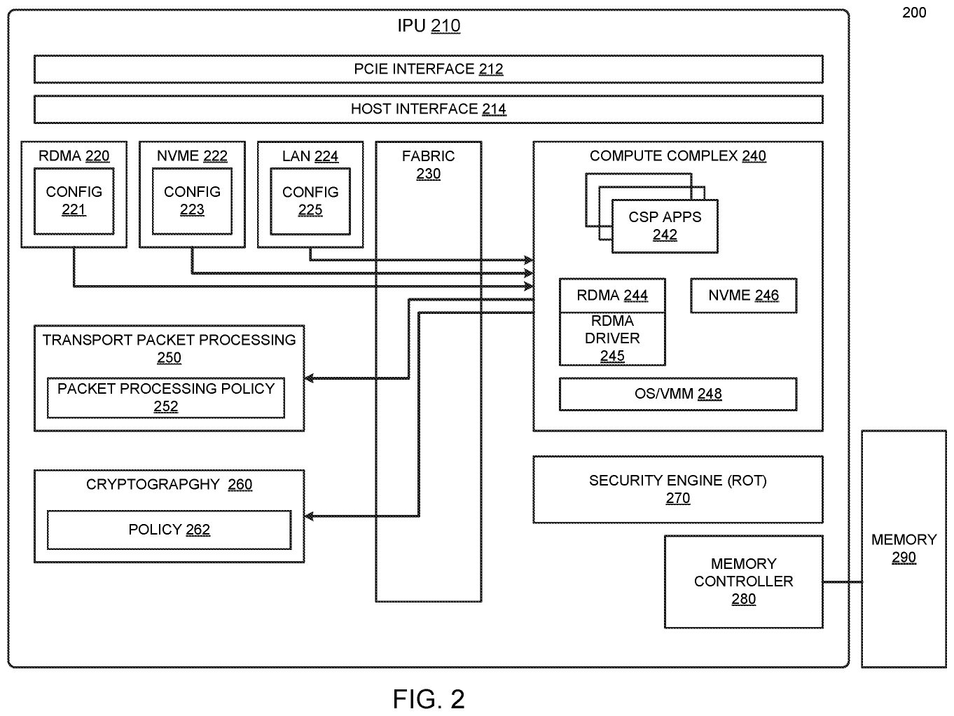

FIG. 2 is a simplified block diagram of at least one embodiment of an infrastructure processing unit 210 in which hardware access control at software domain granularity may be implemented, according to embodiments. Referring to FIG. 2, in one example a computing environment 200 may comprise an infrastructure processing unit (IPU) 210 communicatively coupled to a computer readable (and/or writeable) memory 290. Infrastructure processing unit (IPU) 210 may further comprise a peripheral component interconnect express (PCIe) interface 212 to provide a communication interface with one or more remote devices and a host interface 214 to provide a communication interface with a host device such as a virtualization server 110 depicted in FIG. 1A.

Infrastructure processing unit (IPU) 210 may comprise one or more hardware modules such as a remote direct memory access (RDMA) hardware module 220 which may comprise a configuration file 221, a non-volatile memory express (NVME) hardware module 222 which may comprise a configuration file 223, and a local area network (LAN) hardware module 224 which may comprise a configuration file 225. Infrastructure processing unit (IPU) 210 may comprise a communication fabric 230 and a compute complex 240. One or more compute service provider (CSP) applications 242 may execute on the resources of compute complex 240 under the supervision of a operating system (OS) and/or a virtual machine manager (VMM) 248. Compute complex 240 may further comprise a remote direct memory access (RDMA) module 244 and a remote direct memory access (RDMA) driver 245 and a non-volatile memory express (NVME) module 246.

Infrastructure processing unit (IPU) 210 may comprise a transport packet processing module 250 to implement a packet processing policy 252, a cryptography module 260 to implement a cryptography policy 262, a security engine 270 to establish a root of trust (ROT), and a memory controller 280 to manage memory access requests to computer readable (and/or writeable) memory 290.

As described briefly above, smart Network Interface Controllers (NICs) provide transport services and various acceleration services such as remote direct memory access (RDMA) and storage to host software. As cloud service providers (CSPs) migrate platform and infrastructure control to infrastructure processing units (IPUs), NICs provide a significant security threat potential. Security sensitive workloads need protection of customer data during transport, RDMA, storage etc.

To address these and other issue, subject matter described herein provides apparatus and techniques to implement hardware access control at software domain granularity within an infrastructure processing unit (IPU). In some examples, access control may be managed in a distributed fashion using one or more memory management units (MMUs) communicatively coupled to the fabric 230 of the infrastructure processing unit (IPU) 200. In some examples, the memory management unit(s) (MMUs) may provide a fine-grained access control for read and/or write requests originating from the compute complex 240 to limit access to sensitive regions of memory 290 and to sensitive memory registers to authorized software processes only. In addition, the memory management unit(s) (MMUs) may provide a fine-grained access control for read and/or write requests originating from hardware modules, such that hardware modules can represent different personas such as a software requestor's persona.

In some examples, various hardware modules may be classified based on the type of transaction(s) between the hardware module to memory and software to hardware that can affect tenant security. For example, a target hardware module exposes only control and status registers (CSR) or a region of memory that can be read or written and does not initiate transaction on fabric. Control status registers (CSR) and memory of the module are mapped to memory address ranges. Modules may be accessible by software with access permissions read-only, write-only, or read-write. Module target may need more granularity than “shared” interface/address range accessible to all software domains and “private” interface/address range accessible to only one software domain.

In some examples, interfaces and address range access control can be “shared”, interface/address range accessible to all software domains, and “private”, interface/address range is accessible to only by one software domain. In addition to “shared” and “private”, address range can be assigned to a set of mutually trusting software domains. In some examples, more than one software domain identifier per interface can access the interface/address range or an “access token” that allows access to the interface/address range is distributed to multiple software domains to access the shared interface that is accessible by some software domains but not all software domains as in shared access control.

A target may be implemented with a single assignment, single or multiple interfaces. In this case, the addresses of any interface are assigned to a single owner. The address range of a module can be partitioned into multiple non-overlapping address ranges to form multiple interfaces, each address range or interface is assigned exclusively to a single software domain. Targets with single assignment have interfaces that are all private.

A target may be implemented with multiple assignments, single or multiple interfaces. The address can be partitioned into one or multiple overlapping or non-overlapping address ranges to form one or multiple interfaces, one or multiple software domains may share access to an interface. Interfaces of this type of target may be private, shared, or shared by a mutually trusting set of requestors.

By contrast, a requestor hardware module initiates transactions on fabric that can affect security of the tenant. In some examples, hardware module-initiated access can have permissions read-only, write-only, or read-write.

A requestor hardware module may be implemented with a single personality. In this case, hardware has a single personality designated as a hardware identifier (HWID) to initiate transactions. Hardware can initiate transactions only with the single personality/identification, analogous to a software ID. The point the hardware module connects to the fabric uniquely identifies the hardware module with a single personality, its personality and hardware domain (HWID). When the connection between fabric and hardware module is protected, the hardware module does not have to include its HWID in the request to the SMMU and the SMMU may add the HWID to the request to the fabric.

A hardware requestor may be implemented with multiple personalities. Hardware supports one or more personalities. In some examples, hardware resources may be split into virtual hardware, and each virtual hardware has its HWID/personality. Hardware is multi-tenant.

Each hardware personality can initiate transactions only with its own personality/identification (HWID). The point the hardware module connects to the fabric does not uniquely identifies the virtual requester in the hardware module, its personality and hardware domain. The request of hardware requester must carry the HWID of the virtual hardware to the connection to the fabric.

An entity trusted by the hardware root of trust configures the system memory management unit (SMMU) to match the hardware module personality ID to the corresponding memory address assignment at the interface of the hardware module to block initiation of access to memory range not assigned to hardware module.

The hardware root of trust or an agent trusted by the hardware root of trust programs the secure tables in all the requestors. Hardware root of trust changes in different platforms, in some cases it is the central processing unit (CPU), in others, it could be the infrastructure processing unit (IPU), a field programmable gate array (FPGA), or the platform may have a hardware root of trust in each trusted requestor that mutually authenticate each other. Transactions initiated by the hardware module must carry the unique hardware module ID and/or be integrity protected in case of discrete hardware module. When the communication in the fabric cannot be corrupted (e.g., when the fabric is integrated inside a package and the hardware attackers cannot change transaction or hardware identifier (HWID) on the wires is protected from a physical attack) the fabric does not have to carry the hardware identifier (HWID). In some examples there may be an option to move access control logic to the memory block or add redundant checks at the targets, e.g., at the memory block, in this case, the hardware identifier (HWID) must be carried in the fabric. In some examples there may be an option to implement access control logic integrated to the hardware module instead of in the system memory management unit (SMMU) in the fabric, which requires storage of memory assignment regions in the hardware module. Typically, a requester hardware module also exposes memory/interface and responds to request transactions, i.e., the hardware module that is a requestor typically is also a target. The Hardware module and its target interfaces can be assigned to a single domain or be shared with multiple domains. The hardware requester modules can be any combination of single and multiple requestor while having interfaces that are targets assigned to a single domain or targets assigned to multiple domains. The next paragraphs describe a few combinations.

In some examples, a hardware requestor may be implemented with a single personality and have interfaces assigned to single or multiple domains. In this case, Hardware has a single personality designated as a hardware identifier (HWID). In some examples, hardware can initiate transactions only with the single personality/identification. The hardware module may be assigned to a single SW domain and makes requests with its single personality to memory assigned to the SW domain. In some examples, hardware may be single-tenant. In other examples, the hardware module may have permission to access memory assigned to multiple software domains.

A hardware requestor may be implemented with multiple personalities. Each hardware personality can initiate transactions with its own personality/identification (HWID). Each personality may be assigned to a single software domain. Each personality may initiate access to memory assigned to a single domain. Hardware is multi-tenant. Each personality is single-tenant.

A requestor may be implemented with multiple personalities and multiple domains. Hardware supports one or more personalities. Each Hardware personality can initiate transactions can initiate transactions to memory assigned to more than one software domain.

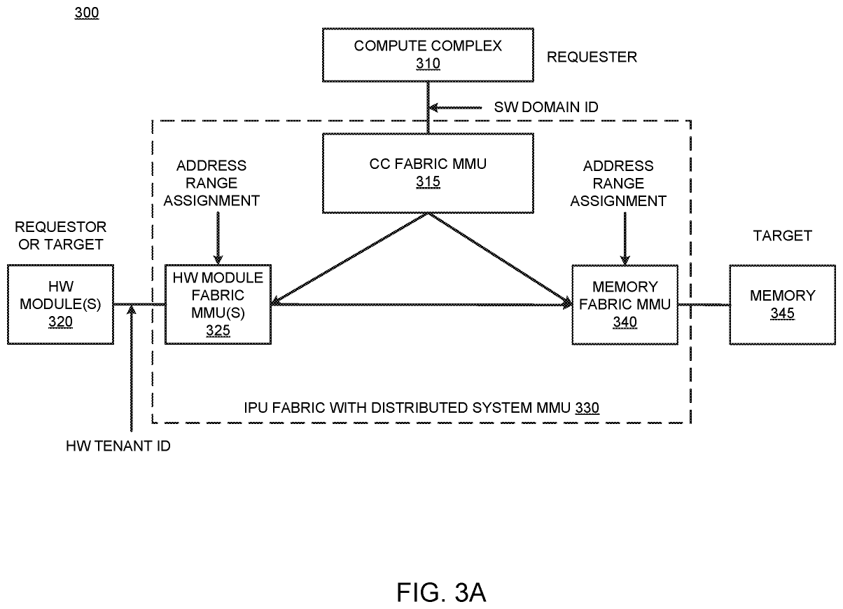

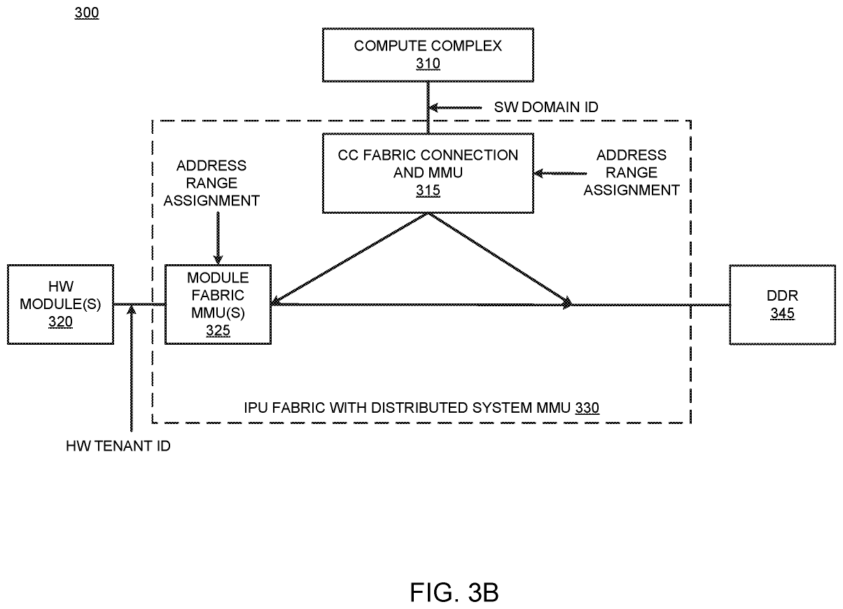

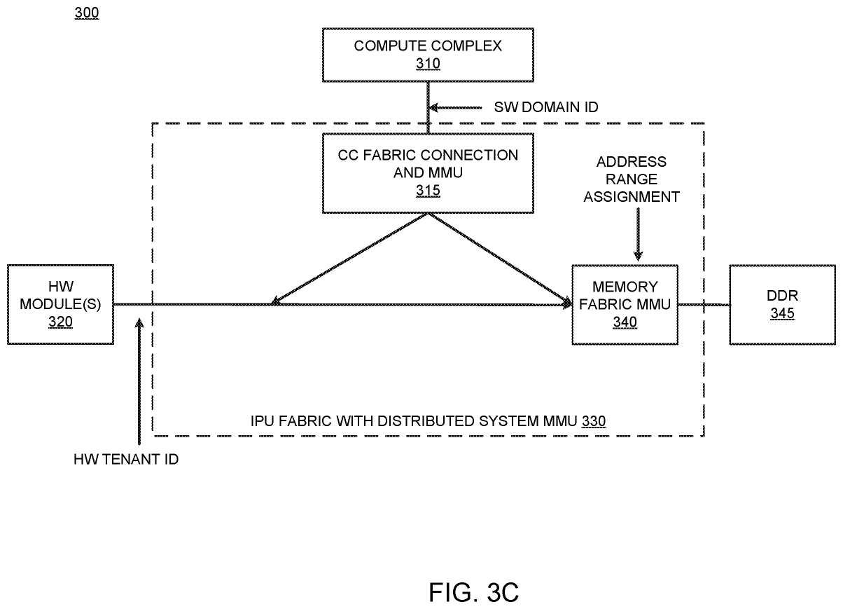

FIGS. 3A-3C illustrate various implementations of an infrastructure processing unit in which hardware access control at software domain granularity may be implemented, according to embodiments. Referring to FIG. 3A, in some examples an infrastructure processing unit (IPU) 300 comprises one or more compute complexes 310, one or more hardware modules represented in the figure as a single 320, and a memory 345, as described with reference to FIG. 2. The infrastructure processing unit 330 comprises a communication fabric with a distributed system memory management unit (MMU) 330. The example of fabric depicted in FIG. 3A comprises a compute complex connection (CC) memory management unit 315, one hardware module memory management unit (MMU) 325, and memory management unit (MMU) 340. A general diagram will have multiple compute complex 310, multiple memory 330 and multiple hardware modules 320, each connected to the fabric through a MMU 315, 345, 325. Some devices in the infrastructure processing unit 300 can act as a requestor, e.g., compute complex 310 and some hardware modules 320, which sends request to read/write address ranges that map to targets in memory 345, or to memory or more registers in hardware modules 320. Alternatively, devices in the infrastructure processing unit 300 can act as a target, which has memory or register resources, and which receives read/write requests from a requestor.

Referring to FIG. 3A, in some examples, the hardware module 320 can initiate memory transactions. Processing circuitry in the hardware module drives the matching hardware tenant ID (hardware identifier or hardware personality) with each request. The hardware module fabric memory management unit 325 at the connection point to the hardware module matches the target address in memory and permissions for the request (read or write) to requestor (e.g., the hardware identifier of the tenant in the hardware module). If the hardware module has a single personality, the hardware module does not have to drive the hardware identifier because it can be inferred by the distributed memory management unit from the point of entry in the fabric at the hardware module 320.

If the hardware module has a single hardware identifier (i.e., personality) shared by multiple tenants and additional access control through different keys at the memory management unit 340 of memory 345 is desired, the hardware identifier may be mapped to a KEYID. Alternatively, encryption keys may be selected by address range such that encryption is not used for access control.

Verification at the hardware module target could be implemented for some hardware modules with no verification in the requestor. For example, on a multi-key total memory encryption (MKTME)-I implementation of memory, read requests using the incorrect key will cause integrity error, and overwrite data with the incorrect key will be detected when the owner of the memory tries to read with the correct key.

In some examples, the compute complex 310 may be a multi-tenant initiator that runs processes of multiple tenants and software domains. The compute complex 310 can initiate access transactions to memory and to the hardware module 320. In some examples, the compute complex 310 may initiate memory mapped input/output (MMIO) and memory transactions to configure the hardware module 320. The compute complex 310 is multi-tenant. In that regard, the compute complex 310 can be viewed as a requestor hardware module that exhibits a multiple domain-personality. In some examples, the compute complex 310 may include the software identifier (SWID) with each memory access request. The compute complex fabric memory management unit (MMU) 310 matches the target address in memory and permissions for the access request (read or write) to the software identifier (SWID) of the requestor.

The compute complex 310 also initiates memory transactions to memory 345 and hardware module 320. Access control of transactions to memory 345 can be enforced with similar mechanisms in the compute complex memory management unit 315 at the interface of the compute complex to the fabric. The compute complex memory management unit 315 stores permissions to pages in memory 345 and permissions to hardware module interfaces mapped to memory pages.

In some examples, memory 345 functions as a target device. Memory 345 does not initiate transactions. In some examples, the memory management unit 340 for memory 345 responds to any transaction arriving from the fabric because it trusts they have been validated at the requestor and the fabric 330 is protected. Optional access control at the interface between the fabric 330 and memory module 345 requires a structure to store permissions and information to enable verification carried with the transaction at 340. Examples include: (a) bit per pages/address range is accessible exclusively by the compute complex 310 or hardware module 320, and the fabric 330 carries a bit identifying software or hardware initiator; (b) a pair of bits per pages/address range if a memory page is accessible by the compute complex 310 and/or a hardware module 320; (c) a bit field of size of hardware identifier and software identifier if enforcing access at the granularity of software and hardware domain; fabric carries hardware identifier and software identifier of requestor; and (d) duplicated fields if permissions for read and write are independent. Distributing access control to the requestor enables implementation of a subset of policies for access control described for memory 345 at the requestor for hardware or software. Structures at the compute complex do not have to store the fields for hardware domains, and structures at hardware modules do not have to store fields for software domains.

Access control functionality of the memory management unit 340 at the memory 345 should be the same whether the requestor is the compute complex 310 or the hardware module 320. For example, integrated hardware in the memory 345 must map software domain identifier or hardware personality identifier to the encryption key identifier and to key if protecting external memory with multi-key total memory encryption (MKTME). In this case, memory 345 must have translation tables for software and hardware domains to KEYID or a unified ID is assigned for the tenant that is configured for hardware and software requestors.

If any of the communication connections are exposed, the connections should be protected with integrity to prevent corruption and encryption to protect confidentiality and access control enforced on all targets. In some cases, access control may be enforced in all targets and no enforcement on requestors or optional enforcement on requestors. For example, if memory 345 is external to the package, the interface between the fabric 300 and memory 345 is protected, and data may be stored encrypted in memory 345. In some examples a cryptography engine integrated in the infrastructure processing unit 300 may encrypt data written to memory or decrypt data read from memory using an encryption key associated with the software domain identifier. For example, integrated hardware maps software or hardware domain identifier to encryption key identifier and to encryption key if protecting external memory with total memory encryption, multi-key (TME-MK).

Referring to FIG. 3B, if integrity on the fabric is protected, access control on the requestors is sufficient. FIG. 3B shows access control for requests from the compute complex in MMU 315 and in MMU 325 of requestor hardware modules. In some examples, hardware modules that cannot initiate a request do not need an MMU 325.

The memory fabric memory management unit 340 at the memory 345 does not have to check permissions because they were already checked at the memory management unit of the requestor. If the memory 345 stored data encrypted and integrity protected and uses different keys to separate tenants (e.g., MKTME-i), the hardware identifier mapping to the memory encryption key protects privacy.

If all hardware modules do not initiate transactions in the fabric, access control at the compute complex 310 is sufficient to implement all access policies if false or corrupted transactions cannot be injected on the fabric 330. The software domain identifier (SWID) does not have to travel on the fabric 330 because access permission was verified at the requestor. The memory management unit (MMU) at the hardware module contact point does not have to validate a transaction request but, if the hardware module finds it useful to also enforce access control, for example, because it has multiple tenants, the software identifier (SWID) is carried in the fabric 330, and assignment to software domain is stored in the hardware module, the memory management unit (MMU) of the hardware module may perform a second verification.

FIG. 3B illustrates an embodiment in which access control is not implemented on the attachment to the fabric of hardware modules that are not requestors and attachment to the fabric of memory 345.

FIG. 3C illustrates an implementation where access control enforcement is not implemented on the hardware module 320 and does not distribute transaction enforcement logic to all hardware modules that can initiate transactions. This embodiment can be used when a hardware module does not target other hardware modules. The embodiment illustrated in FIG. 3C enforces access control of transactions initiated by the compute complex at the compute complex memory management unit (MMU) 315 and enforces transactions targeting memory 345 at the DDR MMU 340. Thus, permissions of transaction of the compute complex 310 to memory is enforced in two places.

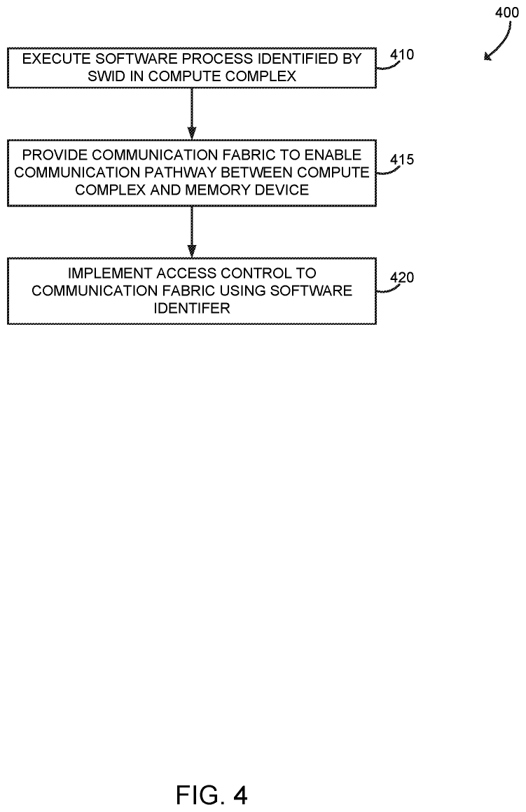

FIG. 4 is a simplified flow diagram of at least one embodiment of a method to implement an infrastructure processing unit in which hardware access control at software domain granularity, in accordance with some embodiments. Referring to FIG. 4, at operation 410 a process software identified by a software identifier (SWID) is executed in a compute complex such as the compute complex 240 depicted in FIG. 2. At operation 415 a communication fabric such as the communication fabric 230 is provided to enable a communication pathway between the compute complex and a memory device such as the computer readable memory 290 depicted in FIG. 2. At operation 420 access control to the communication fabric is implemented using the software identifier.

Illustrative examples of the technologies disclosed herein are provided below. An embodiment of the technologies may include any one or more, and any combination of, the examples described below.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a compute complex comprising one or more processing resources to execute a software process identified by a software identifier (SWID); at least one hardware module; a communication fabric to enable a communication pathway between the compute complex, the at least one hardware module, and at least one memory device; and at least one memory management unit to provide access control to the memory device based at least in part on the software identifier.

Example 2 includes the subject matter of Example 1, wherein the compute complex is a multi-tenant initiator that runs compute processes for multiple tenants and can initiate transactions to the at least one hardware module and to the at least one memory device.

Example 3 includes the subject matter of Examples 1 and 2, wherein the compute complex initiates one or more memory transactions to a target address in the memory device to configure the at least one hardware module, the one or more memory transactions comprising the software identifier (SWID) of a software process initiating the request; and a memory management unit that connects the compute complex to the communication fabric allows the memory access request onto the communication fabric in response to a determination that the software process initiating the request has access to the target address.

Example 4 includes the subject matter of Examples 1-3, wherein the at least one hardware module is a multi-tenant initiator that initiates one or more transactions to the memory device, wherein each transaction in the one or more transactions comprises a unique hardware identifier (HWID) and a memory management unit that connects the at least one hardware module to the communication fabric allows the memory access request onto the communication fabric in response to a determination that the hardware module initiating the request has access to the target address.

Example 5 includes the subject matter of Examples 1-4, wherein a memory management unit that connects the at least one memory device to the communication fabric maintains an access control structure to store access control permissions and information to enable verification of a memory access transaction.

Example 6 includes the subject matter of Examples 1-5, wherein the information to enable verification of a memory access transaction comprises a memory address range accessible by an initiator, the initiator identified by at least one of a hardware identifier (HWID) or a software identifier (SWID).

Example 7 includes the subject matter of Examples 1-6, wherein data transmitted between the communication fabric and the memory device is encrypted.

Some embodiments pertain to Example 8 that includes a processor implemented method comprising executing, in a compute complex comprising one or more processing resources, a software process identified by a software identifier (SWID); providing a communication fabric to enable a communication pathway between the compute complex, the at least one hardware module, and at least one memory device; and implementing, in at least one memory management unit, access control to the memory device based at least in part on the software identifier.

Example 9 includes the subject matter of Example 8, wherein the compute complex is a multi-tenant initiator that runs compute processes for multiple tenants and can initiate transactions to the at least one hardware module and to the at least one memory device.

Example 10 includes the subject matter of Examples 8 and 9, wherein the compute complex initiates one or more memory transactions to a target address in the memory device to configure the at least one hardware module, the one or more memory transactions comprising the software identifier (SWID) of a software process initiating the request; and a memory management unit that connects the compute complex to the communication fabric allows the memory access request onto the communication fabric in response to a determination that the software process initiating the request has access to the target address.

Example 11 includes the subject matter of Examples 8-10, wherein the at least one hardware module is a multi-tenant initiator that initiates one or more transactions to the memory device, wherein each transaction in the one or more transactions comprises a unique hardware identifier (HWID) and a memory management unit that connects the at least one hardware module to the communication fabric allows the memory access request onto the communication fabric in response to a determination that the hardware module initiating the request has access to the target address.

Example 12 includes the subject matter of Examples 8-11, wherein a memory management unit that connects the at least one memory device to the communication fabric maintains an access control structure to store access control permissions and information to enable verification of a memory access transaction.

Example 13 includes the subject matter of Examples 8-12, wherein the information to enable verification of a memory access transaction comprises a memory address range accessible by an initiator, the initiator identified by at least one of a hardware identifier (HWID) or a software identifier (SWID).

Example 14 includes the subject matter of Examples 8-13, wherein data transmitted between the communication fabric and the memory device is encrypted.

Some embodiments pertain to Example 15, that includes at least one non-transitory computer readable medium having instructions stored thereon, which when executed by a processor, cause the processor to execute, in a compute complex comprising one or more processing resources, a software process identified by a software identifier (SWID); provide a communication fabric to enable a communication pathway between the compute complex, the at least one hardware module, and at least one memory device; and implement, in at least one memory management unit, access control to the memory device based at least in part on the software identifier.

Example 16 includes the subject matter of Example 15, wherein the compute complex is a multi-tenant initiator that runs compute processes for multiple tenants and can initiate transactions to the at least one hardware module and to the at least one memory device.

Example 17 includes the subject matter of Examples 15 and 16, wherein the compute complex initiates one or more memory transactions to a target address in the memory device to configure the at least one hardware module, the one or more memory transactions comprising the software identifier (SWID) of a software process initiating the request; and a memory management unit that connects the compute complex to the communication fabric allows the memory access request onto the communication fabric in response to a determination that the software process initiating the request has access to the target address.

Example 18 includes the subject matter of Examples 15-17, wherein the at least one hardware module is a multi-tenant initiator that initiates one or more transactions to the memory device, wherein each transaction in the one or more transactions comprises a unique hardware identifier (HWID) and a memory management unit that connects the at least one hardware module to the communication fabric allows the memory access request onto the communication fabric in response to a determination that the hardware module initiating the request has access to the target address.

Example 19 includes the subject matter of Examples 15-18, wherein a memory management unit that connects the at least one memory device to the communication fabric maintains an access control structure to store access control permissions and information to enable verification of a memory access transaction.

Example 20 includes the subject matter of Examples 15-19, wherein the information to enable verification of a memory access transaction comprises a memory address range accessible by an initiator, the initiator identified by at least one of a hardware identifier (HWID) or a software identifier (SWID).

Example 21 includes the subject matter of Examples 15-20, wherein data transmitted between the communication fabric and the memory device is encrypted.

The details above have been provided with reference to specific embodiments. Persons skilled in the art, however, will understand that various modifications and changes may be made thereto without departing from the broader spirit and scope of any of the embodiments as set forth in the appended claims. The foregoing description and drawings are, accordingly, to be regarded in an illustrative rather than a restrictive sense.

What is claimed is:

1. An apparatus, comprising:
a compute complex comprising one or more processing resources to execute a software process identified by a software identifier (SWID);
at least one hardware module;
a communication fabric to enable a communication pathway between the compute complex, the at least one hardware module, and at least one memory device; and
at least one memory management unit to provide access control to the memory device based at least in part on the software identifier.

2. The apparatus of claim 1, wherein:
the compute complex is a multi-tenant initiator that runs compute processes for multiple tenants and can initiate transactions to the at least one hardware module and to the at least one memory device.

3. The apparatus of claim 1, wherein:
the compute complex initiates one or more memory transactions to a target address in the memory device to configure the at least one hardware module, the one or more memory transactions comprising the software identifier (SWID) of a software process initiating the request; and
a memory management unit that connects the compute complex to the communication fabric allows the memory access request onto the communication fabric in response to a determination that the software process initiating the request has access to the target address.

4. The apparatus of claim 1, wherein:
the at least one hardware module is a multi-tenant initiator that initiates one or more transactions to the memory device, wherein each transaction in the one or more transactions comprises a unique hardware identifier (HWID) and
a memory management unit that connects the at least one hardware module to the communication fabric allows the memory access request onto the communication fabric in response to a determination that the hardware module initiating the request has access to the target address.

5. The apparatus of claim 4, wherein:
a memory management unit that connects the at least one memory device to the communication fabric maintains an access control structure to store access control permissions and information to enable verification of a memory access transaction.

6. The apparatus of claim 5, wherein the information to enable verification of a memory access transaction comprises:
a memory address range accessible by an initiator, the initiator identified by at least one of a hardware identifier (HWID) or a software identifier (SWID).

7. The apparatus of claim 1, wherein data transmitted between the communication fabric and the memory device is encrypted.

8. A method, comprising:
executing, in a compute complex comprising one or more processing resources, a software process identified by a software identifier (SWID);
providing a communication fabric to enable a communication pathway between the compute complex, the at least one hardware module, and at least one memory device; and
implementing, in at least one memory management unit, access control to the memory device based at least in part on the software identifier.

9. The method of claim 8, wherein:
the compute complex is a multi-tenant initiator that runs compute processes for multiple tenants and can initiate transactions to the at least one hardware module and to the at least one memory device.

10. The method of claim 8, wherein:
the compute complex initiates one or more memory transactions to a target address in the memory device to configure the at least one hardware module, the one or more memory transactions comprising the software identifier (SWID) of a software process initiating the request; and
a memory management unit that connects the compute complex to the communication fabric allows the memory access request onto the communication fabric in response to a determination that the software process initiating the request has access to the target address.

11. The method of claim 8, wherein:
the at least one hardware module is a multi-tenant initiator that initiates one or more transactions to the memory device, wherein each transaction in the one or more transactions comprises a unique hardware identifier (HWID) and
a memory management unit that connects the at least one hardware module to the communication fabric allows the memory access request onto the communication fabric in response to a determination that the hardware module initiating the request has access to the target address.

12. The method of claim 11, wherein:
a memory management unit that connects the at least one memory device to the communication fabric maintains an access control structure to store access control permissions and information to enable verification of a memory access transaction.

13. The method of claim 12, wherein the information to enable verification of a memory access transaction comprises:
a memory address range accessible by an initiator, the initiator identified by at least one of a hardware identifier (HWID) or a software identifier (SWID).

14. The method of claim 8, wherein data transmitted between the communication fabric and the memory device is encrypted.

15. One or more non-transitory computer-readable storage media comprising instructions stored thereon that, in response to being executed, cause a computing device to:
execute, in a compute complex comprising one or more processing resources, a software process identified by a software identifier (SWID);
provide a communication fabric to enable a communication pathway between the compute complex, the at least one hardware module, and at least one memory device; and
implement, in at least one memory management unit, access control to the memory device based at least in part on the software identifier.

16. The one or more non-transitory computer-readable storage media of claim 15, wherein:
the compute complex is a multi-tenant initiator that runs compute processes for multiple tenants and can initiate transactions to the at least one hardware module and to the at least one memory device.

17. The one or more non-transitory computer-readable storage media of claim 15, wherein:
the compute complex initiates one or more memory transactions to a target address in the memory device to configure the at least one hardware module, the one or more memory transactions comprising the software identifier (SWID) of a software process initiating the request; and
a memory management unit that connects the compute complex to the communication fabric allows the memory access request onto the communication fabric in response to a determination that the software process initiating the request has access to the target address.

18. The one or more non-transitory computer-readable storage media of claim 15, wherein:
the at least one hardware module is a multi-tenant initiator that initiates one or more transactions to the memory device, wherein each transaction in the one or more transactions comprises a unique hardware identifier (HWID) and
a memory management unit that connects the at least one hardware module to the communication fabric allows the memory access request onto the communication fabric in response to a determination that the hardware module initiating the request has access to the target address.

19. The one or more non-transitory computer-readable storage media of claim 18, wherein:
a memory management unit that connects the at least one memory device to the communication fabric maintains an access control structure to store access control permissions and information to enable verification of a memory access transaction.

20. The one or more non-transitory computer-readable storage media of claim 19, wherein the information to enable verification of a memory access transaction comprises:
a memory address range accessible by an initiator, the initiator identified by at least one of a hardware identifier (HWID) or a software identifier (SWID).

21. The one or more non-transitory computer-readable storage media of claim 15, wherein data transmitted between the communication fabric and the memory device is encrypted.
